(19) United States
(12) Patent Application Publication
(10) Pub. No.: US 2026/0218714 A1
(43) Pub. Date: Jul. 30, 2026

(54) HYGIENIC STEAM COMPRESSOR

(71) Applicant: SPX Flow Technology Danmark A/S, Silkeborg (DK)

(72) Inventors: Ole POULSEN, Silkeborg (DK); Bent PEDERSEN, Hojbjerg (DK)

(21) Appl. No.: 19/141,537

(22) PCT Filed: Dec. 19, 2023
(86) PCT No.: PCT/IB2023/062950

§ 371 Date: Jun. 20, 2025

Related U.S. Application Data
(60) Provisional application No. 63/433,881, filed on Dec. 20, 2022.

(51) Int. Cl. F04D 17/10; A23B 2/40; F04D 25/06; F04D 29/42; F04D 29/70

(52) U.S. Cl. CPC F04D 17/10; A23B 2/40; F04D 25/06; F04D 29/4206; F04D 29/701

(57) ABSTRACT

A hygienic compression device having an impeller housing, an impeller, and a motor. The impeller housing having an axial inlet and radial outlet. The axial inlet receiving flash steam from a flash steam outlet of a flash vessel. The radial outlet suppling compressed flash steam to a heat treatment apparatus. The impeller is disposed in the impeller housing. The motor is configured to rotate the impeller. Flash steam enters the inlet and is radially accelerated and compressed in response to rotation of the impeller.

### CROSS-REFERENCE TO RELATED APPLICATIONS

This application claims priority to U.S. Provisional Application 63/433,881 (filed on December 20, 2023) which is incorporated by reference in its entirety.

### FIELD OF THE INVENTION

The disclosure relates to a steam compressor for use in a plant for ultra-high temperature treatment of fluid foodstuffs such as milk or milk-based products, baby food, plant-based drinks, or nutritious drinks, the plant comprising a direct heat treatment apparatus in which the fluid is heat treated by way of supply of steam.

### BACKGROUND OF THE INVENTION

In a UHT plant (Ultra High Temperature plant), steam is e.g., sprayed into a fluid foodstuff in an infusion chamber, in such a manner that the fluid foodstuff is heated to a temperature of approximately 140° C. Subsequently, the fluid foodstuff is fed to a so-called holding chamber in which the fluid foodstuff is kept for a predetermined period (approximately 2 to 15 sec) in the heated state. Thereafter, the fluid foodstuff is transferred to a flash vessel in which the water deriving from the steam is removed in such a manner that the solid content of the fluid foodstuff leaving the flash vessel is the same as that which was fed into the infusion chamber, before being subjected to the heat treatment. After being processed in the flash vessel, the fluid foodstuff is usually transferred to a homogenizer and then subjected to cooling and packing.

EP 0 794 706 discloses an infusion plant for high temperature treatment of fluid foodstuffs such as whey protein concentrate and cheese milk. The plant has an infusion chamber, in which the fluid is subjected to heat treatment by means of steam fed into the infusion chamber. The foodstuff is introduced at the top of the infusion chamber as a bundle of separate and mainly downwardly directed jets. The lower section of the infusion chamber serves to collect the foodstuff and has cooled walls provided with a cooling jacket. An outlet opening of the infusion chamber is arranged at the bottom of the infusion chamber and the outlet opening is connected to the inlet of a positive-displacement pump. The outlet of the positive-displacement pump is connected to the inlet of a vacuum chamber that serves to remove water from the foodstuff that was added during the steam infusion.

U.S. Pat. No. 4,419,301 discloses a process for heating fluids to a sterilization temperature. The fluid is heated by direct contact with steam while it is in the form of a very thin, freefalling film or continues falling stream. After the sterilization process the added steam is removed in a flash vessel and the generated steam is condensed to a condensate, which is discarded.

AU 61233 discloses an infusion plant for continuously sterilizing liquids, where unsterilized liquid is sprayed, preferably after preheating, into a sterilizing chamber fed with steam whit the liquid heated by the steam is kept for a predetermined period, characterized in that at the top of the sterilizing chamber (see Infusion chamber [15] in FIG. 1) comprises at least one row of downward-directed outlet openings for the liquid, said openings being situated along a circle. This plant has an infusion chamber, in which the fluid is subjected to heat treatment by means of steam fed into the infusion chamber. An outlet opening of the infusion chamber is arranged at the bottom of the infusion chamber and the outlet opening is connected to the inlet of a holding device. The outlet of the holding device is connected to the inlet of a vacuum chamber [FIG. 1, item 7] that serves to remove water from the foodstuff that was added during the steam infusion.

WO 2022/122401 discloses a process for heating fluids to a sterilization temperature. The fluid is heated by direct contact with steam by a Steam Injection device.

After the heating added steam is removed in flash vessel cooling device and the steam is condensed to a condensate, which is discarded. This disclosure describes the use of steam injection instead of steam infusion, but has same cooling device, a flash cooler where excess steam is condensed and discarded The infusion plant uses high temperature for a short period of time in order to kill micro-organisms. This technology is widely used in the dairy industry where products can lose their nutritional value, flavor, and appearance as micro-organisms multiply. These organisms thrive at certain temperatures but if they are not present in a product, the product can be stored for many months without the need for refrigeration. Steam infusion achieves this objective with minimal heat degradation compared to other UHT processes. It helps protect essential components such as vitamins and results in fresh tasting products with outstanding quality. It provides the necessary kill rate for commercial sterility and can handle a wide product viscosity range, covering fluids from milk, puddings, ice cream, baby food, condensed milk, processed cheese, plant-based drinks, sauces, and creams to lotions.

There is a constant need for improving the design and function of heat treatment plants such as infusion plants to achieve a process which is increasingly cost and energy effective and more environmentally friendly than prior art.

Accordingly, it is desirable to provide hygienic steam compressor for a heat treatment plant without the undesirable qualities of conventional steam compressors.

### SUMMARY OF THE INVENTION

It is an object of the invention to provide a hygienic steam compressor for use in an infusion plant for ultra-high treatment of fluid foodstuffs which is more cost effective and more environmentally friendly than prior art due to improved internal heat recovery.

This object is achieved according to a first aspect of the invention by providing a compression device having an impeller housing, an impeller, and a motor. The impeller housing having an axial inlet and radial outlet. The axial inlet receiving flash steam from a flash steam outlet of a flash vessel. The radial outlet suppling compressed flash steam to a heat treatment apparatus. The impeller is disposed in the impeller housing. The motor is configured to rotate the impeller. Flash steam enters the inlet and is radially accelerated and compressed in response to rotation of the impeller.

This object is achieved according to a second aspect of the invention by providing a plant for heat treating fluid foodstuffs, such as milk, milk based products, baby food, baby food liquid concentrates, or nutritious drinks, the plant comprising: a heat treatment apparatus having a fluid foodstuff inlet arranged at a top of the heat treatment apparatus, a fluid foodstuff outlet arranged at a bottom of the heat treatment apparatus, and a first steam inlet arranged at a top of the heat treatment apparatus, the fluid foodstuff being subjected to heat treatment by feeding live steam and/or flash steam into the heat treatment apparatus, the live steam being fed into the heat treatment apparatus by means of a live steam conduit connected to the first steam inlet, a flash vessel having a fluid foodstuff inlet at the side of the vessel and a fluid foodstuff outlet at a bottom of the flash vessel, the fluid foodstuff outlet of the heat treatment apparatus being connected to the fluid foodstuff inlet of the flash vessel by means of a conduit and a pump, the fluid foodstuff outlet of the flash vessel being connected to a conduit and a pump for draining off fluid foodstuff from the flash vessel, the flash vessel further comprising a flash steam outlet arranged at the top of the flash vessel, the flash steam outlet being connected to a flash steam conduit, the flash steam conduit being connected to an inlet of a compression arrangement, wherein the flash steam conduit is adapted for feeding the flash steam to the compression arrangement, in which compression arrangement the flash steam is compressed, and a second flash steam conduit is connected to an outlet of the compression arrangement, the second flash steam conduit being adapted for transferring the flash steam to the heat treatment apparatus.

Embodiments of the invention allow the low-pressure waste flash steam of a UHT plant to be reused instead of just being released to the atmosphere. The waste flash steam is around 50% loss of the UHT plant heating energy, so when added 1000 kg steam for Infusion UHT heating, conventional direct UHT lose 500 kg steam through waste flash steam. With a flash steam recovery system, such as that of the invention, all this 50% waste flash steam heat can be recovered and reused. Embodiments of this invention increase reuse from 50% to 100% of steam for Infusion heating.

In a first possible implementation form of the first aspect, the second flash steam conduit is connected to the live steam conduit, allowing the heat treatment apparatus to have only one steam inlet.

In a second possible implementation form of the first aspect, the second flash steam conduit is connected to a second steam inlet arranged at the top of the heat treatment apparatus, providing a solution where one can regulate the injection of live steam and flash steam independently of each other.

In a third possible implementation form of the first aspect, a thermal vapor recompression device is connected to the second flash steam conduit, compressing the flash steam further if necessary.

In a fourth possible implementation form of the first aspect, the compression arrangement comprises at least one compression device, facilitating mechanical compression of the flash steam to a higher pressure such that it can be reused.

In a fifth possible implementation form of the first aspect, the compression arrangement comprises two compression devices connected in series, allowing steam pressure to be reduced in suitably large steps.

In a sixth possible implementation form of the first aspect, the compression device comprises a steam compressor.

In a seventh possible implementation form of the first aspect, the compression device comprises a heat pump.

In a ninth possible implementation form of the first aspect, the compression device comprises a turbocharger, further reducing the amount of energy needed to operate the plant.

In a tenth possible implementation form of the first aspect, the live steam is generated by means of a steam boiler, which is a simple and reliable solution.

In an eleventh possible implementation form of the first aspect, the steam boiler is adapted for providing steam to the turbocharger, removing the need for powering the turbocharger separately.

In a twelfth possible implementation form of the first aspect, the conduit and pump are adapted for transferring the fluid foodstuff to an aseptic homogenizer.

In a thirteenth possible implementation form of the first aspect, the fluid foodstuffs are heat sensitive.

In a fourteenth possible implementation form of the first aspect, the plant does not comprise a condenser connected to an outlet of the flash vessel.

In a fifteenth possible implementation form of the first aspect, the heat treatment apparatus comprises a steam infusion chamber.

In a sixteenth possible implementation form of the first aspect, the heat treatment apparatus comprises a steam injector device.

The object is achieved according to a second aspect of the invention by means of a method for operating a ultra-high temperature treatment plant with a heat treatment apparatus, in which fluid foodstuff is subjected to heat treatment by means of live and/or flash steam, the method comprising: feeding the fluid foodstuff into the heat treatment apparatus, feeding live steam and/or flash steam into the heat treatment apparatus, removing the fluid foodstuff from the heat treatment apparatus, feeding the fluid foodstuff into a flash vessel, removing the fluid foodstuff from the flash vessel, removing flash steam from the flash vessel, feeding the flash steam to a compressor arrangement, the compressor arrangement compressing the flash steam, where after the flash steam is fed into the heat treatment apparatus. The method allows the low-pressure waste flash steam of a UHT plant to be reused instead of just being released to the atmosphere. With a flash steam recovery system, such as that of the invention, all the 50% waste steam can be recovered and reused, so the Infusion chamber only needs to be filled with external live steam in the start sequence so in an aspect of the invention, after the start-up, the Infusion chamber heating can be done on reuse steam with no external live steam supply. In a first possible implementation form of the second aspect, the compressor arrangement comprises at least two compressor devices, alternatively three compressor devices, alternatively four compressor devices, arranged in series, and the flash steam is compressed incrementally by means of the compressor devices. Such a solution facilitates stepwise mechanical compression of the flash steam. In certain embodiments, when the compressor devices are connected in series, the connection includes water injection.

In a second possible implementation form of the second aspect, at least two of the steps are executed simultaneously.

In a third possible implementation form of the second aspect, the method further comprises feeding the flash steam through a thermal vapor recompression device, after having compressed the flash steam in the compressor arrangement and prior to feeding the flash steam into the heat treatment apparatus.

In a fourth possible implementation form of the second aspect, the heat treatment apparatus comprises a steam infusion chamber.

In a fifth possible implementation form of the second aspect, the heat treatment apparatus comprises a steam injector device.

The foregoing and other objects are achieved by the features of the independent claims. Further implementation forms are apparent from the dependent claims, the description, and the figure.

These and other aspects of the invention will be apparent from the figure and the embodiments described below.

### BRIEF DESCRIPTION OF THE DRAWINGS

The foregoing summary, as well as the following detailed description of the invention, will be better understood when read in conjunction with the appended figures. For the purpose of illustrating the invention, the figures demonstrate embodiments of the present invention. It should be understood, however, that the invention is not limited to the precise arrangements, examples, and instrumentalities shown.

FIG. 1 is a diagrammatic view of an embodiment of an ultra-high temperature treatment plant.

FIG. 2 is an orthogonal view of an impeller and a semi-transparent impeller housing suitable for use in a compression device in the ultra-high temperature treatment plant of FIG. 1.

FIG. 3 is a cross-sectional view of the compression device with the mounted impeller and the impeller housing suitable for use in the ultra-high temperature treatment plant of FIG. 1.

### DETAILED DESCRIPTION

In general, embodiments of a compression device described herein are suitable for use with any system that includes a compression device. The compression device is suitable for use with the ultra-high temperature treatment (“UHT”) plant described herein. For example, as described herein, advantages of the compression device include: providing energy savings in the production of steam for food processing; allow hygienic cleaning of impeller and impeller housing; allows motor for compression device to be separated from food-handling portion of the ultra-high temperature treatment plant; and the like. It is a particular advantage of the compression device described herein that it is suitable for use with Mechanical Vapor Recompression (MVR) processes to enable energy savings in the re-use of steam. MVR can enable the UHT plant to reduce evaporation energy use by 90% or more.

MVR uses energy recovered from the flash steam to mechanically generate high-pressure/high-energy steam that can be re-used. From Boyle's law it is known for a gas that PV/T (Pressure*Volume/Temperature) is constant (PV/T=K). During compression of vapor, the pressure and temperature increase. From this, the heat energy can be reused. The energy normally lost in the compression is recovered, leading to a highly efficient UHT process loop. These and other advantages are described herein. More particularly, embodiments of the compression device described herein are suitable for various types of process plants.

Specifically, in certain embodiments, the disclosure provides aseptic hygienic steam compressor device is intended for use in an Infusion MVR loop. The compressor device is an integral part of the heat pump circuit that reuse flash vessel steam thereby reduce fresh steam consumption and reduce energy consumption. In some embodiments, the compressor device can operate as single compressor but can also operate in series with other compressor devices where some desuperheating is required. In some embodiment, where the compressor devices operate in series, the compressor comprises water injection before, inside or after the compressor. In addition, or alternatively, desuperheating may be achieved via a heat exchange and/or gas injection. The gas may be CO₂, for example.

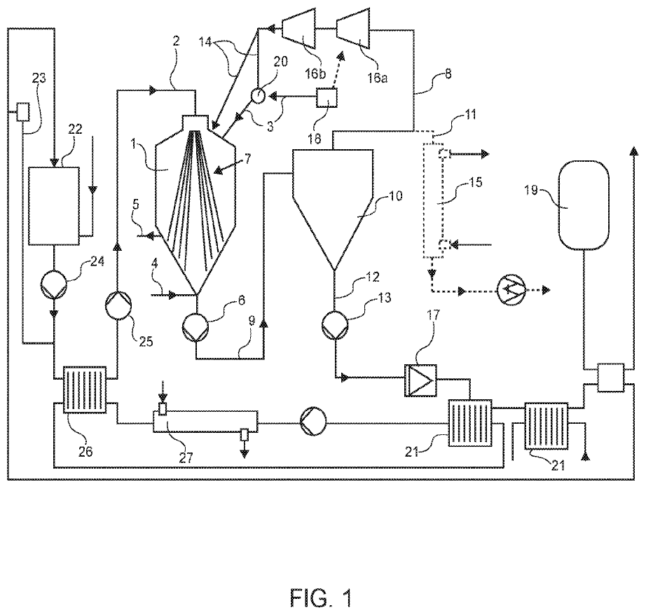

FIG. 1 shows a plant for ultra-high temperature treatment of liquid foodstuff. The liquid foodstuff can be any foodstuff in liquid form, but the disclosed plant is particularly useful for temperature sensitive foodstuffs that should be heated for killing bacteria for a short period only so as to preserve their flavor, consistency, and nutritious qualities. Examples of such liquid foodstuffs are milk, milk-based products, baby food, baby food liquid concentrates, or nutritious drinks. The liquid foodstuff may have a high dry matter content (40% and higher) and/or high protein content (6% or higher). The fluid foodstuff is initially stored in a tank 22. The tank 22 is connected to a sterilization loop 23 in which the foodstuff is sterilized. The fluid foodstuff is transferred from the tank 22 by means of a conduit 2 and pumps 24, 25 to a heat treatment apparatus 1. Midway, the conduit 2 is connected to a plate heat exchanger 26 for preheating the fluid foodstuff from approximately 1° C. to approximately 100° C. or, more particularly from approximately 5° C. to approximately 75° C.

The fluid foodstuff enters the heat treatment apparatus 1, e.g., a steam infusion chamber, as a bundle of separate liquid foodstuff jets 7 through a plurality of openings in a nozzle at the top of the steam infusion chamber 1. Hot steam is injected into the steam infusion chamber 1 through a steam inlet, e.g., a circumferential steam distribution chamber. In the steam infusion chamber 1 the liquid foodstuff jets meet the hot steam and the foodstuff is thereby heated and absorbs the steam.

In an embodiment, the heat treatment apparatus 1 comprises a steam injector device instead of a steam infusion chamber. The steam injector device heats the foodstuff by mixing foodstuff from conduit 2 with steam from conduit 14 and/or conduit 3 inside the steam injector device. The following description will, however, refer only to a steam infusion chamber, for the sake of simplicity.

The steam infusion chamber 1 is preferably essentially rotation symmetrical around a vertical axis. The upper section of the steam infusion chamber 1 has a hollow cylindrical part and a top part that is shaped similar to a conical frustum. A bottom section is releasably connected to the upper section by a flanged connection for allowing access to the interior of the steam infusion chamber 1 for cleaning and/or maintenance. The bottom section has in an embodiment a shape similar to a conical frustum.

Further, the steam infusion chamber 1 is connected to conduits 4 and 5 used for feeding and removing liquid, e.g., water, for cooling the bottom of the steam infusion chamber 1. A cooling jacket, connected to the conduits 4, 5, may be provided around the bottom section. The cooling jacket keeps the bottom section cool to prevent or minimize the liquid foodstuff that gets into contact with the inner walls of the bottom section to foul or burn-on. The cooling jacket provides for a mantle of cooling water or other cooling medium around the bottom section. The mantle is divided by a spiral traverse wall that guides the cooling water in a spiral pattern around the bottom section. The cooling medium inlet passes through a pump housing and into a portion of the mantle that extends also into the pump housing. From the portion internal to the pump housing the spiral path of the cooling medium continues spirally upwards towards a cooling medium outlet, connected to conduit 5, at the top of the cooling jacket and near the top of the bottom section. The liquid foodstuff jets end on the funnel shaped inner wall of the bottom section. The bottom section collects the liquid foodstuff from the liquid foodstuff jets and guides it to the outlet opening at the lower end of the steam infusion chamber 1, which is also the lower end of the bottom section, and which is also the inlet of the pump 6.

The lower portion of the bottom section forms the outlet opening of the steam infusion chamber 1 which, in one embodiment, connects seamlessly to the inlet of the pump 6 and, in another embodiment, is just connected to pump 6. This is, in one embodiment, achieved by the lower end of the bottom section being made from steel plates, such as e.g., stainless steel, and connected to the pump housing by welds. In an embodiment, the pump housing is provided with a circular ridge or circular upright flange that facilitates welding of the pump housing to the lower end of the bottom section. After welding the transition between the bottom section and the pump housing/pump inlet formed by the welds is machined to provide a perfectly smooth surface without and cracks or fissures that could be difficult to clean or rinse.

The pump 6 may be a centrifugal pump or a positive displacement pump. The pump 6 is of a conventionally known type, e. g., a gear or lobe pump, and connected to the outlet of the steam infusion chamber 1. The housing of the pump 6 is provided with a temperature sensor at a location where the adjacent surface is kept clean of burnings by means of e.g., the teeth of the gear wheels or by the lobes of the rotors. In this manner, it is possible to ensure a reliable control of the plant. In another embodiment, the temperature sensor is a pin probe sensor located directly after the pump 6, at the start of conduit 9. The outlet of the pump 6 is connected to the inlet of a flash vessel 10, e.g., a vacuum chamber, of a conventionally known type by means of a conduit 9. In one embodiment conduit 9 includes a valve at the end of conduit 9, just before flash vessel 10.

The flash vessel 10 is adapted for removing the water which was added to the fluid foodstuff during heat treatment in the steam infusion chamber 1. The excess water, added by the steam during the heat treatment, is removed through a steam conduit 8. The concentrated fluid foodstuff is drained off through a conduit 12 and a pump 13 in a conventionally known manner and is transferred to an aseptic homogenizer 17. Thereafter, the homogenized fluid foodstuff is cooled by means of one or several plate heat exchangers 21, for example from approximately 75° C. down to approximately 20° C. and transferred to a storage unit 19 or a packaging process. In other examples, the homogenized fluid foodstuff is cooled from as hot as 95° C. down to a room temperature of approximately 20° C., refrigeration temperature of approximately 5° C., and transferred to a storage unit 19 or a packaging process.

The plate heat exchangers 21 and 26 are connected in a continuous heating/cooling loop, along with a water heater 27, which heats the heating water just before it enters preheater 26.

In prior art, low-pressure steam, such as flash steam, is usually vented to the atmosphere or condensed in a cooling tower. Instead, low-pressure waste steam can be mechanically compressed to a higher pressure such that it can be reused. Steam tables show that when steam condenses, around 25% of its heat remains in the condensate, i.e., the concentrated fluid foodstuff. With a flash steam recovery system, such as that shown in FIG. 1, around half of this heat can be recovered as flash steam. However, the UHT process requires that the flash steam, which is in direct contact with the foodstuff, is of food quality.

The steam infusion chamber 1 has a fluid foodstuff inlet arranged at the top of the steam infusion chamber 1, a fluid foodstuff outlet arranged at the bottom of the steam infusion chamber 1, and a first steam inlet also arranged at the top of the steam infusion chamber 1. By “top” is meant an upper section of the steam infusion chamber, and by “bottom” is meant a lower section of the steam infusion chamber, as seen when the steam infusion chamber is arranged such that it extends essentially vertically.

Heat-sensitive fluid foodstuff is fed to the fluid foodstuff inlet by means of conduit 2, and is subjected to heat treatment, within the steam infusion chamber 1, by feeding live steam and/or flash steam into the steam infusion chamber 1. By “live steam” is meant steam, which is generated, e.g., by means of a steam boiler. By “flash steam” is meant steam which is recovered from the flash vessel. The live steam is fed into the steam infusion chamber 1, through the first steam inlet, by means of a live steam conduit 3. The other end of the steam conduit 3 is connected to a steam boiler. A steam boiler produces steam at approximately 7-20 bar. The steam which is fed into the steam infusion chamber 1 has a pressure of approximately 5 bar. A control valve may therefore be used to throttle back the amount of steam and create a pressure drop from 7-15 bar and down to 5 bar. In a preferred embodiment, a turbocharger reuses this pressure drop as power driving the turbocharger.

The flash vessel 10 has a fluid foodstuff inlet at the top of the flash vessel 10 and a fluid foodstuff outlet at the bottom of the flash vessel 10. By “top” is meant an upper section of the flash vessel, and by “bottom” is meant a lower section of the flash vessel, as seen when the flash vessel is arranged such that it extends essentially vertically. The inlet at the top is a horizontal and tangential inlet at the top The fluid foodstuff outlet of the steam infusion chamber 1 is connected to the fluid foodstuff inlet of the flash vessel 10 by means of a conduit 9 and a pump 6. The fluid foodstuff outlet of the flash vessel 10 is connected to a conduit 12 and a pump 13 for draining off fluid foodstuff from the flash vessel 10.

The flash vessel 10 comprises a flash steam outlet arranged at the top of the flash vessel 10. The flash steam outlet is connected to a first flash steam conduit 8. As the flash steam exits the flash vessel 10, in a particular example it has a temperature of approximately 70° C. and an absolute pressure which is approximately 0.3 bar. In other examples, the flash steam may have a temperature ranging from approximately 50° C. to approximately 90° C. and an absolute pressure ranging from approximately 0.1 bar to approximately 1.0 bar.

The first flash steam conduit 8 is connected to the inlet of the compression arrangement 16 and is used for feeding the flash steam from the flash vessel 10 to the compression arrangement 16. The flash steam is thereafter compressed within the compression arrangement, to approximately 2-10 bar or, more particularly from approximately 5-7 bar and a temperature of approximately 100-200° C. or, more particularly, approximately 130-170° C. after desuperheating.

The outlet of the compression arrangement 16 is connected to a second flash steam conduit 14 which is used for transferring the flash steam to the steam infusion chamber 1. In one embodiment, the second flash steam conduit 14 is connected to the live steam conduit 3 such that live steam and flash steam is mixed before entering the steam infusion chamber 1 through the first steam inlet. In another embodiment, the second flash steam conduit 14 is connected directly to a second steam inlet arranged at the top of the steam infusion chamber 1. In this embodiment, live steam is fed into the steam infusion chamber 1 through the first steam inlet and flash steam is fed into the steam infusion chamber 1 through the second steam inlet. Both of these embodiments may be combined.

Further, the second flash steam conduit 14 may be connected to a compression device, such as a device for thermal vapor recompression 20, also known as TVR. If the flash steam, when leaving the compression arrangement 16, has a pressure lower than desirable, such as under 5 bar, e.g., 4 bar, the compression device, e.g., the thermal vapor recompression device, may be used to compress the flash steam further up to the desirable pressure, such as 5 bar. In certain embodiment, the flash steam exiting the compression device, e.g., the TVR, has a pressure higher than 5 bar. The thermal vapor recompression device 20 is connected to the second flash steam conduit 14 and to the live steam conduit 3. The thermal vapor recompression device compresses the flash steam about 1-7 bar, more preferable 1-3 bar.

The compression arrangement 16 comprises one compression device 16a, two compression devices 16a, 16b connected in series or three compression devices 16a, 16b, and 16c connected in series. In certain embodiments, when connected in series, the flash steam conduit 8 is connected to the inlet of a first compression device 16a, and the second flash steam conduit 14 is connected to the outlet of a second compression device 16b and, optionally, the third compression device 16c. Otherwise, the flash steam conduit 8 is connected to the inlet of the compression device 16a, and the second flash steam conduit 14 is connected to the outlet of the same compression device 16a. In certain embodiments, the compression device is used in combination with another compression device, e.g., a thermal vapor recompression device, connected to the second flash steam conduit.

The compression device 16a, 16b, and/or 16c may comprise a steam compressor, a heat pump, or a turbine. A turbine may be more efficient in transferring high volumes. The compression device 16a, 16b, and/or 16c may also comprise a turbocharger, which is powered by steam provided by the previously mentioned control valve/steam boiler. The turbocharger may increase the energy savings further, since the energy used to drive the turbocharger is “free.” The steam pressure from the steam boiler is, as previously mentioned, much higher than that which is needed in the steam infusion chamber 1. Today's prior art is provided with a steam throttle valve between the boiler and the steam infusion chamber. This throttle valve reduces the steam pressure from 7-15 bar down to 4 bar, and all the high-pressure energy is lost as friction energy in the throttle. When using a turbocharger instead of a throttle valve, the high-pressure steam is lead through the drive turbine of the turbocharger and is in this way provided with almost free power to drive the turbocharger. In specific embodiments, the compression device has a single screw compressor type arrangement.

In certain embodiments, the compression device 16a, 16b, and/or 16c are of a sanitary design. In other embodiments, when two or more compression devices are used in series, the plant is configured to provide for de-superheating between the stages. In some embodiments, when the two or more compression devices are used in series, the two or more compression devices are connected to each other via a connection that includes water injection before, inside or after each compressor.

The compression arrangement 16 may comprise two identical kinds of compression devices, such as two steam compressors, or two different kinds of compression devices, such as a steam compressor and a turbine. Alternatively, the compression arrangement 16 may comprise three identical kinds of compression devices, such as three steam compressors, or three different kinds of compression devices, such as a steam compressor and a turbine. In addition, desuperheating may be employed following some or all of the compression devices. In a particular example, water injection may be used to desuperheat the steam to a saturated steam, for example.

In prior art, the first flash steam conduit 8 would be connected to a condenser conduit 11 instead of the compression device 16a, 16b. The condenser conduit 11 is connected to a condenser 15 and feeds the flash steam to the condenser 15. The flash steam is cooled in the condenser and subsequently released into the atmosphere.

Without being bound by theory, it is thought that the compressor devices of the disclosure especially when used in series reduce the amount of energy used in infusions systems. Unlike the compressor devices of the disclosure, indirect heat pump solution currently used do not offer the needed energy efficiency and indirect heat pump offer no water reduction. Conventional indirect heat pump solutions typically have an efficiency of COP=2 for UHT systems. It is therefore and advantage that the direct recompression disclosed herein has an improved efficiency of COP=4.

The UHT plant is operated by means of the following method. The method comprises a number of steps, executed in a continuous loop. However, at least two of these steps are executed simultaneously. Fluid foodstuff is fed into the steam infusion chamber 1. Simultaneously, live steam is fed into the steam infusion chamber 1 through a first steam inlet and flash steam is fed through the first steam inlet or the second steam inlet, such that the fluid foodstuff is heat treated by the live steam and the flash steam. After heat treatment, the fluid foodstuff is removed from the steam infusion chamber 1 and fed into a flash vessel 10. Condensed fluid foodstuff is, after treatment, removed from the lower section of the flash vessel 10. Simultaneously, flash steam is removed from the upper section of the flash vessel 10. The flash steam is thereafter fed to a compressor arrangement 16. The compressor arrangement 16 compresses the flash steam from approximately −0.7 bar to approximately 5 bar. The flash steam is compressed incrementally by means of two compressor devices 16a, 16b, connected in series. Alternatively, the flash steam is compressed incrementally by means of three or 4 compressor devices 16a, 16b, 16c connected in series.

After compression, the flash steam is fed into the infusion chamber 1. In one embodiment, the method further comprises the step of feeding the flash steam through a thermal vapor recompression device 20, after having compressed the flash steam in the compressor arrangement 16, and prior to feeding the flash steam into the steam infusion chamber 1.

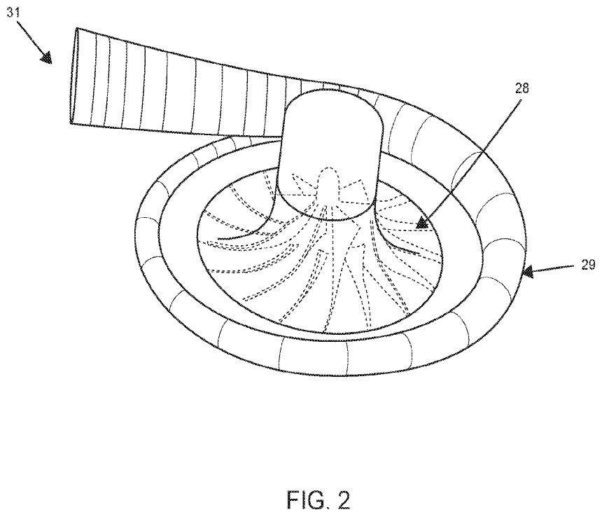

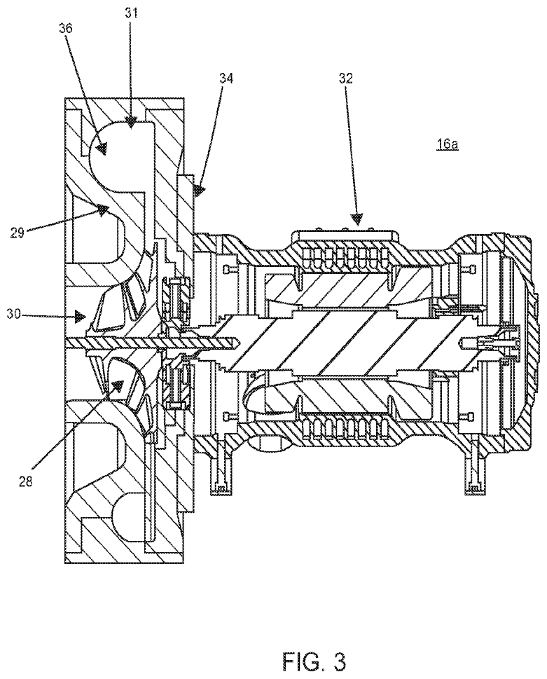

In the following FIGS. 2-3, a particular embodiment of a compression device 16a is described that is suitable for use in the plant for treating fluid foodstuffs described herein. It is an advantage of this embodiment that the compression device 16a is a high-temperature and high-pressure compressor. For the purposes of this disclosure, the term, “high-temperature compressor” is defined as a compressor with an inlet temperature of 70-90° C. and an outlet temperature of 120-170° C. after desuperheating. In contrast, conventional mechanical compressors operate at temperatures below 50° C. The term, high-pressure compressor” as used herein refers to a compressor with a pressure-ratio (“PR”) in the range of 11-20. In contrast, conventional mechanical compressors operate at a PR of less than 2.

In general, the compression device 16a shown in FIGS. 2-4 is aseptic and/or hygienic. For example, hygienic design defines contact surfaces as having surface roughness 0.8-1.2 Ra and easy clean in place (“CIP”) cleanable inside contact surfaces without being dismantled. Because of very high velocities (>5 meter/sec) in cleaning, hygienic geometric design requirements (max radius & max surface roughness) are slightly below American 3A rules and European Hygienic Engineering and Design Group (“EHEDG”) guidelines and still fully CIP cleanable compressors. In addition, the compression device 16a may include no visible or exposed threads, bolts, and nut inside compressor process room. This contributes to hygienic compressor design.

While other compressible fluids, such as CO₂, are contemplated, in a preferred example, the compression device 16a is configured to compress steam only and the compression device 16a may, optionally utilize steam as an indirect media.

FIG. 2 is an orthogonal view of an impeller 28 and a semi-transparent impeller housing 29 suitable for use in the compression device 16a, 16b, and/or 16c in the UHT plant of FIG. 1. For the sake of brevity, FIGS. 2-3 will be described with reference to compression device 16a, however, the compression device 16b and/or 16c may be the same or different and the compression arrangement 16 may include additional compression devices. As shown in FIG. 2, the compression device 16a includes an inlet 30 and outlet 31. The inlet 30 is axial and the outlet 31 is radial. In response to rotation of the impeller 28, flash steam introduced via the inlet 30 is accelerated radially. In a generally understood manner, the radially accelerated steam is driven toward the outlet with sufficient energy that the steam may be compressed. The compression of the steam results in an increase of temperature and thus, the flash steam may be increased in energy so that it can be fed back into the live steam conduit 3 as shown in FIG. 1.

As shown in FIG. 2 via the blade configuration of the impeller 28, the impeller 28 is configured to perform as a centrifugal high-speed compressor impeller, for example. For the purposes of this disclosure, the term, “centrifugal high-speed compressor impeller” refers to an impeller configured to rotate at greater than 20,000 revolutions per minute (“rpm”). These rotational speeds are an order of magnitude greater than conventional Mechanical Vapor Recompression machines for evaporators, that operate at speeds of less than 3000 rpm.

In certain embodiments, compressor device 16a, 16b, and/or 16c is configured so that impeller 28 spins at 20,000 rpm to 75,000 rpm, alternatively 35,000 rpm to 45,000 rpm, alternatively 40,000 rpm to 42,000 rpm. The tip speed of the impeller 28 is configured to be greater than 300 meters per second (“m/s”), for example the tip speed may be 400-580 m/s or preferably 450-550 m/s, for example.

The compressor devices of the disclosure are of a sanitary design. Specifically, the impeller housing 29 and impeller 28 facilitate aseptic and/or hygienic cleaning of the impeller housing 29 and the impeller 28 thereby allowing the device to be sanitary. In this regard, the impeller housing 29 may be removably secured to a housing mounting plate 34 via a series of bolts (Not shown). The housing mounting plate 34 may be part of a partition or chamber that separates the motor 32 from a food-handling area. This facilitates an ease of cleaning and may prolong the life of the motor 32 by reducing exposure to cleaning fluids. This advantage of separating the motor 32 from the impeller housing 29 and the food-handling area is further enhanced by the axial inlet 30 and radial outlet 31. That is, the redirection of the steam from the axial to the radial direction may help facilitate the ability to isolate the motor 32 from the food-handling area of the UHT plant.

FIG. 3 is a cross-sectional view of the compression device 16a with the impeller 28 and an impeller housing 29 according to another embodiment. The compressor device 16a shown in FIG. 3 is similar to the compressor device 16a described hereinabove and thus, for the sake of brevity, those features already described will not be described again. The example of the impeller housing 29 shown in FIG. 3 may be secured to the motor 32 via a back side of the housing mounting plate 34. In this manner, the steam process side can be cleaned without cleaning media entering the motor compartment. Also shown in the cross section of the impeller housing 29 in FIG. 3, a collection conduit 36 is configured to collect the steam driven outward via the rotation of the impeller 28. The increasing cross-sectional area of the collection conduit 36 is shown in FIG. 3 as well as FIG. 2.

A shaft seal for the compression device 16a may include an axial seal type with the seal media flowing in an axial direction only. The seal media flow direction is toward the process side (impeller room) which differs from conventional compressors.

Of note, the various contact surfaces of the compression device 16a may be configured for hygienic food contact. For example, materials used in the impeller 28 and impeller housing 29 may be stainless steel or other such materials suitable for use in food contact. The surface finish may be suitably smooth and internal radiuses may be suitable large to facilitate CIP operations. Furthermore, internal threads, “dead legs” or pockets may be eliminated from the compression device 16a.

The invention has been described in conjunction with various embodiments herein. However, other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. The reference signs used in the claims shall not be construed as limiting the scope.

It is noted that, as used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As used herein, the term “approximately” when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

As used herein, the terms “comprising,” “including,” “containing” and “characterized by” are exchangeable, inclusive, open-ended and do not exclude additional, unrecited elements or method steps. Any recitation herein of the term “comprising,” particularly in a description of components of a composition or in a description of elements of a device, is understood to encompass those compositions and methods consisting essentially of and consisting of the recited components or elements.

As used herein, the term “consisting of” excludes any element, step, or ingredient not specified in the claim element.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A hygienic compression device comprising:
an impeller housing having an axial inlet and radial outlet, the axial inlet to receive flash steam from a flash steam outlet of a foodstuff system flash vessel, the radial outlet to supply compressed flash steam to a heat treatment apparatus;
an impeller disposed in the impeller housing; and
a motor configured to rotate the impeller, wherein flash steam entering the inlet is radially accelerated and compressed in response to rotation of the impeller.

2. The compression device according to claim 1, wherein the motor is configured to rotate the impeller at greater than 20,000 revolutions per minute (rpm).

3. The compression device according to claim 1, wherein a tip speed at an outside circumference of the impeller is greater than 300 meters per second (m/s).

4. The compression device according to claim 1, wherein the compression device is configured to generate a saturated steam temperature of 120-170° C. at the radial outlet.

5. The compression device according to claim 1, wherein the compression device is configured to generate a pressure ratio in a range of 11-20 at the radial outlet of last compressor relative to the axial inlet pressure of first compressor.

6. The compression device according to claim 1, wherein the compression device is configured to facilitate cleaning in place (CIP) without disassembly.

7. The compression device according to claim 1, further comprising a housing mounting plate disposed between the motor and the impeller housing, wherein the motor is isolated from the impeller and the impeller housing to facilitate aseptic hygienic cleaning of the impeller and the impeller housing without subjecting the motor to cleaning fluids use for aspect cleaning.

8. A plant for heat treating fluid foodstuffs having the compression device according to claim 1.

9. The plant according to claim 8, wherein the plant comprises at least two compression devices connected in series.

10. The plant according to claim 8, wherein the plant comprises three or four compression devices connected in series.

11. The plant according to claim 8 , wherein the plant comprises water injection before, inside or after the compression devices connected in series to de-superheat the fluid foodstuffs.

12. The plant according to claim 8, wherein the compression device is removably attached to the plant.

13. The plant according to claim 12, wherein the compression device is configured to allow for aseptic hygienic cleaning of the plant.

14. A method of compressing flash steam generated in an ultra-high temperature treatment plant with a heat treatment apparatus, in which fluid foodstuff is subjected to heat treatment via compressed flash steam, the method comprising:
feeding the fluid foodstuff into the heat treatment apparatus;
feeding live steam and/or flash steam into the heat treatment apparatus;
removing the fluid foodstuff from the heat treatment apparatus;
feeding the fluid foodstuff into a flash vessel;
removing the fluid foodstuff from the flash vessel;
removing flash steam from the flash vessel; and
feeding the flash steam to a hygienic compressor arrangement having a compression device, the compression device comprising:
an impeller housing having an axial inlet and radial outlet, the axial inlet to receive flash steam from a flash steam outlet, the radial outlet to supply compressed flash steam to a flash steam conduit;
an impeller disposed in the impeller housing; and
a motor configured to rotate the impeller, wherein flash steam entering the inlet is radially accelerated and compressed in response to rotation of the impeller; and the hygienic compressor arrangement compressing the flash steam, where after the flash steam is fed into the heat treatment apparatus.

15. The method according to claim 14, wherein the ultra-high temperature treatment plant comprises two compression devices arranged in series and the flash steam is compressed incrementally by the two compression devices.

16. The method according to claim 14, wherein the ultra-high temperature treatment plant comprises three or four compression devices arranged in series and the flash steam is compressed incrementally by the three or four compression devices.

17. The method according to claim 15, further comprising de-superheating before, inside or after the compression devices arranged in series.

18. The method according to claim 17, wherein the de-superheating comprises water injection cooling or cooling by heat exchanger.

19. The method according to claim 14, wherein the compression device is cleaned by cleaning-in-place cleaning of the impeller and the impeller housing alone, without cleaning the motor.

20. A plant for heat treating fluid foodstuffs, the plant comprising:
a heat treatment apparatus having a fluid foodstuff inlet arranged at a top of the heat treatment apparatus;
a fluid foodstuff outlet arranged at a bottom of the heat treatment apparatus; and
a first steam inlet arranged at a top of the heat treatment apparatus, the fluid foodstuff being subjected to heat treatment by feeding live steam and/or flash steam into the heat treatment apparatus, the live steam being fed into the heat treatment apparatus by a live steam conduit connected to the first steam inlet, a flash vessel having a fluid foodstuff inlet at a top of the flash vessel and a fluid foodstuff outlet at a bottom of the flash vessel, the fluid foodstuff outlet of the heat treatment apparatus being connected to the fluid foodstuff inlet of the flash vessel by a conduit and a pump, the fluid foodstuff outlet of the flash vessel being connected to a conduit and a pump for draining off fluid foodstuff from the flash vessel, the flash vessel further comprising a flash steam outlet arranged at the top of the flash vessel, the flash steam outlet being connected to a first flash steam conduit, the first flash steam conduit being connected to an inlet of a compression arrangement, the first flash steam conduit being adapted for feeding the flash steam to the compression arrangement, in which compression arrangement the flash steam is compressed, a second flash steam conduit being connected to an outlet of the compression arrangement, the second flash steam conduit being adapted for transferring the flash steam to the heat treatment apparatus, wherein the compression arrangement comprises:
an impeller housing having an axial inlet and radial outlet, the axial inlet to receive flash steam from the flash steam outlet, the radial outlet to supply compressed flash steam to the second flash steam conduit;
an impeller disposed in the impeller housing;
a motor configured to rotate the impeller, wherein flash steam entering the inlet is radially accelerated and compressed in response to rotation of the impeller; and
a hygienic cleanable compressor arrangement.

21. The plant according to claim 20, wherein the compression arrangement further comprises a housing mounting plate disposed between the motor and the impeller housing, wherein the motor is isolated from the impeller and the impeller housing to facilitate aseptic cleaning of the impeller and the impeller housing without subjecting the motor to cleaning fluids use for aspect cleaning.

22. The plant according to claim 20, wherein the impeller housing and impeller are independently cleaned from the motor by hygienic cleaning of the impeller housing and impeller.

23. The plant according to claim 20, wherein the compression arrangement further comprises a plurality of compression devices.

24. The plant according to claim 20, further comprising a water injection device disposed before, inside or after the compression arrangement to desuperheat the compressed flash steam.

25. The plant according to claim 20, further comprising an aseptic design, for UHT sterilized foodstuff products.
